(19) United States
(12) Patent Application Publication
(10) Pub. No.: US 2006/0142943 A1
(43) Pub. Date: Jun. 29, 2006

(54) Navigation service method and terminal of enabling the method

(76) Inventor: Yong Sun Park, Seoul (KR)

Correspondence Address: LADAS & PARRY LLP, 224 SOUTH MICHIGAN AVENUE, SUITE 1600, CHICAGO, IL, 60604, US

(21) Appl. No.: 11/317,760

(22) Filed: Dec. 23, 2005

(30) Foreign Application Priority Data
Dec. 27, 2004 (KR) 10-2004-0113362

(51) Int. Cl. G01C 21/28

(52) U.S. Cl. 701/213

(57) ABSTRACT

Disclosed is a navigation service method using geographic information, comprising the steps of: storing geographic data in a database, the geographic data including network data for indicating geographic coordinates, calculating a route, and matching a GPS (Global Positioning System) code received from GPS satellites and the geographic coordinates, point data having position information for a search, and background data that is an aerial photograph or a satellite photograph; searching for a desired position or calculating a current position according to a GPS code in the case of receiving the GPS code from the GPS satellites; loading background data and map data about a predetermined area including the current position from the database; and generating map image data overlapping the loaded map data and background data and displaying the generated map image data to a display.

### CROSS-REFERENCE TO RELATED APPLICATIONS

This application claims the benefit of Korean Patent Application No. 2004-113362, filed on Dec. 27, 2004, in the Korean Intellectual Property Office, the disclosure of which is incorporated herein in its entity by reference.

### BACKGROUND OF THE INVENTION

1. Field of the Invention

The present invention relates to a navigation service, and more particularly, to a navigation service method capable of using an aerial photograph or a satellite photograph as background data and a terminal of enabling the method.

2. Description of the Related Art

A GPS (Global Positioning System) is a worldwide position determining system using satellites. A navigation system uses a GPS receiver to receive radio waves transmitted from a satellite to determine an exact position, determines how long it takes to reach a target location, and determines a route to the target place.

The GPS method of determining a position uses four-dimensions, time (T) and coordinates (X, Y, Z). Accordingly, the GPS is applicable to position observation and speed observation of a high-speed moving object, such as an airplane, a ship, and an automobile. Also, the GPS may perform observations at any time and obtain data in observation time in units of seconds.

The GPS uses NAVSTAR (Navigation Satellite Timing and Ranging) satellites which was originally military satellites of the United States. Since 1988, at least three satellites whose orbital period is 0.5 sidereal day (about 11 hours 58 minutes) are provided at the same interval in each of six circular orbits. In this case, the circular orbit has altitude 20,183 km, inclination of satellite orbit 55° and longitude of ascending node 60°. Accordingly, any position in the world may be determined by using at least three satellites Position determining signals received from the GPS satellite include a P (precision or protect) code which is a high precision code and L1 and C/A (clear and acquisition) Code which is a low precision code. Only L1 and C/A codes are open to a general user. The P code is limited to military use because of agreements between governments.

The L1 and C/A codes are intentionally assigned with an error SA (selective availability) in the United States. Their precision is within about 100 m. However, as technologies develop and the L1 and C/A codes are widely used, the U.S government removed the intentional error SA in May of 2000. Accordingly, error rate was reduced considerably.

Also, various methods of correcting error with respect to a position measured by GPS are currently being developed. Methods include a method of developing a DGPS (Differential GPS) which corrects an error to within about Im, and the like. In this instance, the DGPS installs a GPS reference station that is a ground reference, and measures a relative position.

As described above, as a gradually advanced GPS technology and a GIS (Geographic Information System) are integrated, users may use more various and convenient geographic information service.

The GIS is a system enabling display of geographical shape and provides results in the form of a map via a query or an analysis of a relational database. In the case of the GIS, many types of geographic data include important geographic shape data. Accordingly, the GIS is used in various fields such as weather forecast, population forecast, a land use plan, and the like

Geographic data of the GIS may include network data, point data, background data, and the like. In this instance, the network data indicates geographic coordinates such as latitude and longitude, military coordinates of one country and the like, and calculates a route, and matches a coordinate position received from a GPS. The point data indicates a POI (point of interest) displaying the inclusive shape such as a road address, a postal code, a location of a forest, and the like. Also, the background data indicates geographical features.

The geographic data may be stored in the form of a vector or a raster.

The vector form is to indicate data in X and Y coordinates. The vector form is useful in indicating a nonlinear shape, such as river or roads that may be indicated in X and Y coordinates points or the boundary of an urban district that may be displayed by the closed curve of coordinates. Accordingly, map data and point data of the geographic data may have the vector form.

The raster form indicates data in which grid cells continuously change, and is useful for indicating a change such as the type of soil in one region. Accordingly, background data of the geographic data may be in raster form.

Generally, the GIS uses the above two types of data.

The geographic data is periodically updated via a field survey and is compiled of data. Currently, an aerial photograph and a satellite photograph in order to quickly cope with the transformation of a topographical object may be added.

As described above, Japan's Fujitsutensa adding an aerial photograph and a satellite photograph to quickly cope with the transformation of a topographical object disclosed a technology of segmenting the screen of a navigation system into at least two and displaying a map image according to geographic data on one screen and displaying a satellite photograph of a corresponding region on another screen.

However, the aforementioned technology of Japan's Fujitsutensa had to add image data about a satellite photograph to existing geographic data. Namely, image data and vector data for background data were simultaneously included. Accordingly, a database became large. Because of this problem, other three-dimensional topographical information and image information were not indicated.

Also, in the case of using only background data of geographic data to prevent the database from becoming large, a three-dimensional topographical image or illustration image may not be expressed. Namely, it was difficult to quickly cope with the transformation of a topographical object. Also, in the case of changing background data of geographic data on the basis of the transformation of a topographical object, it was very complicated and took a very long time. Accordingly, maintenance and repair was very difficult.

Accordingly, the development of a technology capable of quickly readjusting to the transformation of a topographical object was needed.

### SUMMARY OF THE INVENTION

To solve the aforementioned problems in the conventional art, the present invention provides a navigation service method capable of quickly readjusting to the transformation of a topographical object and readily performing maintenance and repair, and a terminal of enabling the method.

The present invention also provides a navigation service method capable of effectively managing background data indicating the transformation of a topographical object and preventing a database from becoming large.

To achieve the above objectives and solve the aforementioned conventional problems, according to an aspect of the present invention, there is provided a navigation service method, including the steps of: storing geographic data in a database, the geographic data including network data for indicating geographic coordinates, calculating a route, and matching a GPS (Global Positioning System) code received from GPS satellites and the geographic coordinates; point data having position information for a search; and background data that is an aerial photograph or a satellite photograph; searching for a desired position or calculating a current position according to a GPS code in the case of receiving the GPS code from the GPS satellites; loading background data and map data about a predetermined area including the current position from the database; and generating map image data overlapping the loaded map data and background data and displaying the generated map image data to a display.

The present invention utilizes an aerial photograph or a satellite photograph, a topographical image, and an illustrated map image as background data in the form of a layer and quickly readjusting to the transformation of a topographical image. Also, the present invention reduces the burden of maintenance and repair.

Also, the present invention selectively utilizes an aerial photograph or a satellite photograph, a topographical image, and an illustrated map image as background data. Accordingly, the present invention may effectively use a database.

### BRIEF DESCRIPTION OF THE DRAWINGS

The above and other features and advantages of the present invention will become more apparent by describing in detail exemplary embodiments thereof with reference to the attached drawings in which:

FIG. 1 is a configuration diagram illustrating a navigation service system according to an exemplary embodiment of the present invention;

FIG. 2 is a configuration diagram illustrating a navigation service terminal according to an exemplary embodiment of the present invention;

FIG. 3 is a flowchart illustrating a method of constructing geographic data according to an exemplary embodiment of the present invention;

FIG. 4 is a diagram illustrating a configuration example of geographic data according to an exemplary embodiment of the present invention;

FIGS. 5 to 7 are diagrams illustrating an example of image adopted as background data according to an exemplary embodiment of the present invention;

FIGS. 8 and 15 are flowcharts illustrating a navigation service method according to an exemplary embodiment of the present invention;

FIGS. 9 to 11 are diagram illustrating an example of a map image according to an exemplary embodiment of the present invention;

FIG. 12 is a diagram illustrating an example of adopting an aerial photograph as background data;

FIG. 13 is a diagram illustrating an example of adopting a topographical image as background data; and

FIG. 14 is a diagram illustrating an example of segmenting a display screen and adopting an illustrated map and an aerial photograph on each segmented screen as background data.

### DETAILED DESCRIPTION OF THE INVENTION

Hereinafter, an embodiment of the present invention will be described in detail with reference to the accompanying drawings.

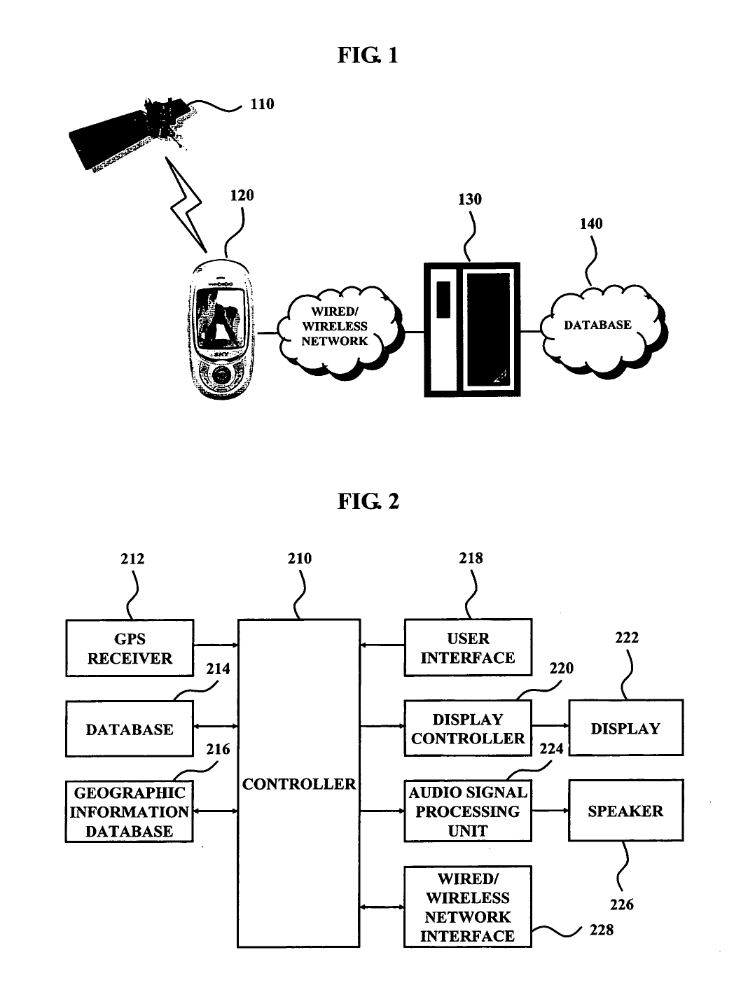

FIG. 1 is a configuration diagram illustrating a navigation service system according to an exemplary embodiment of the present invention.

Referring to FIG. 1, a GPS (Global Positioning System) satellite 110 transmits various codes for calculating a position. A navigation service terminal 120 receives various codes transmitted from the GPS satellite 110, calculates a current position, and informs a user of the current position by using embedded geographic data or calculates a route to a position requested by the user and guides the user through the calculated route. The navigation service terminal 120 accesses a navigation service server 130 via a wired/wireless network, downloads updated geographic data, and updates embedded geographic data. The navigation service server 130 constructs geographic data according to an exemplary embodiment of the present invention and stores the constructed geographic data in a database 140. In the case a request for downloading is received from the navigation service terminal 120, the navigation service server 130 downloads the geographic data to the navigation service terminal 120. In this instance, the geographic data includes map data, point data, and background data. An aerial photograph or a satellite photograph, a topographical image, and an illustrated map image may be selectively adopted as the background data.

The configuration of the navigation service terminal 120 will be described in further detail with reference to FIG. 2.

A controller 210 of the navigation service terminal 120 controls the navigation service terminal 120. Also, the controller 210 calculates a current position via various codes (hereinafter, referred to as GPS code) received from a GPS receiver 212 and generates a map image by using geographic data stored in the database 214. Also, the controller 210 indicates a current position on the generated map image or displays a map image indicating a route between the current position and a predetermined position on a display 222. Also, the controller 210 outputs audio signals from a speaker 226 to inform a user of a current position or guide a user through a route. Also, the controller 210 accesses the navigation service server 130 via a wired/wireless network, downloads new geographic data and stores the same in the database 214.

The GPS receiver 212 receives a GPS code from the GPS satellites 110, and transmits the received GPS code to the controller 210. The database 214 stores geographic data and updates the stored geographic data according to the control of the controller 210.

A geographic information database 216 stores various types of data including a process program of the controller 210.

A user interface 218 provides the controller 210 with various types of commands or information inputted from a user by using a keypad or a touch panel.

The display controller 220 controls the display 222 to display various types of information including a map image according to the control of the controller 210.

An audio signal processing unit 224 converts audio data according to the control of the controller 210 into an audio signal and controls a speaker 226 to output the audio signal.

A wired/wireless network interface 228 controls access with a wired/wireless network and enables the connection between the controller 210 and the navigation service server 130.

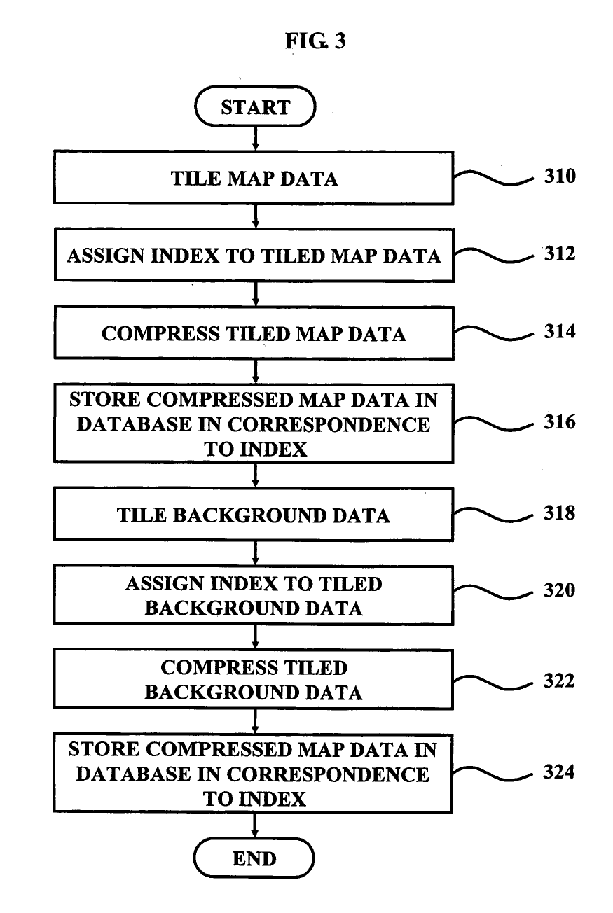

A method of constructing geographic data according to the present invention will be described with reference to FIG. 3.

The geographic data includes map data, point data, and background data. The map data and the background data are compressed and stored. Hereinafter, only a process of storing map data and background data will be described. The geographic data may be constructed in an unillustrated manager terminal that is connected to the navigation service server 130, and uploaded thereto. A general purpose computer may be adopted for the manager terminal.

In step 310, when a request for constructing geographic data is received, the manager terminal tiles map data in predetermined unit areas. In step 312, when tiling of the map data is completed, the manager terminal assigns an index to each tiled map data. In steps 314 and 316, the manager terminal compresses each map data assigned with the index and stores the compressed map data in correspondence to the index.

In step 318, the manager terminal tiles background data into predetermined unit areas. In step 320, when tiling of the background data is completed, the manager terminal assigns an index to each tiled background data. In steps 322 and 324, the manager terminal compresses each background data assigned with the index and stores the compressed background data in correspondence to the index.

The order of storing the map data and the background data may be changed.

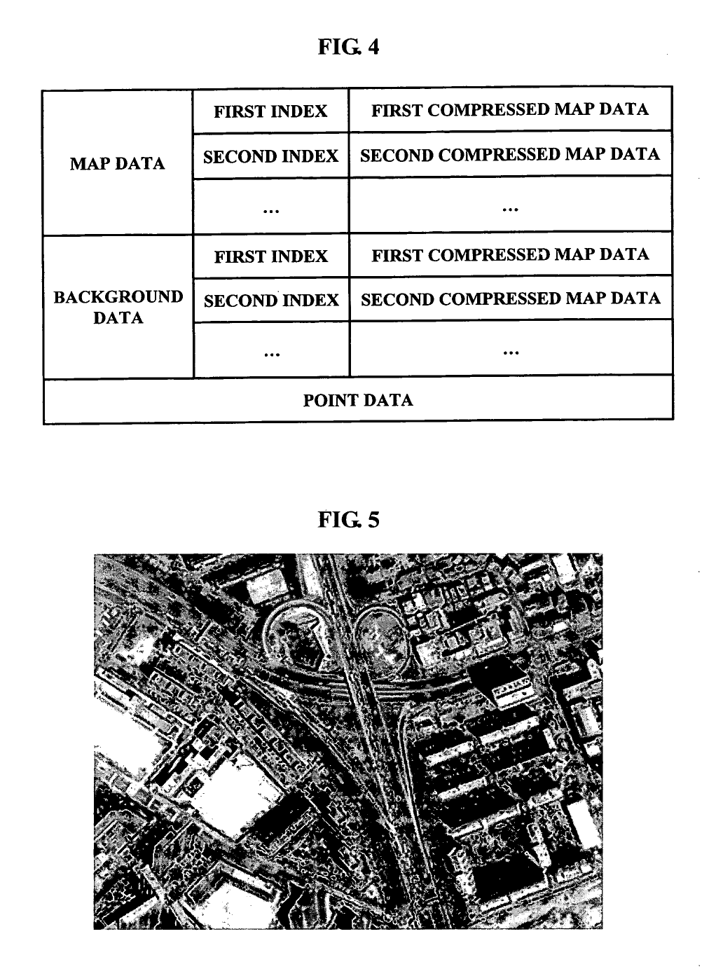

The geographic data constructed as above includes map data, background data, and point data as illustrated in FIG. 4. In particular, the map data and the background data are divided into a plurality of tiles and compressed and stored. An index is assigned to each compressed map data and background data.

An image used as background data of the geographic data will be described with reference to FIGS. 5 to 7.

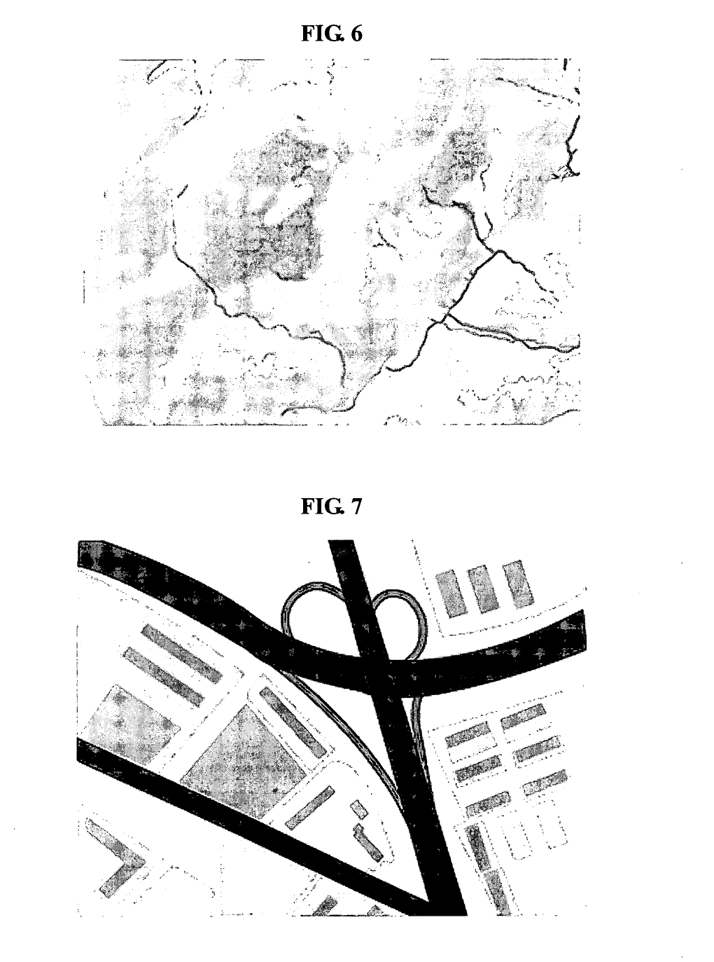

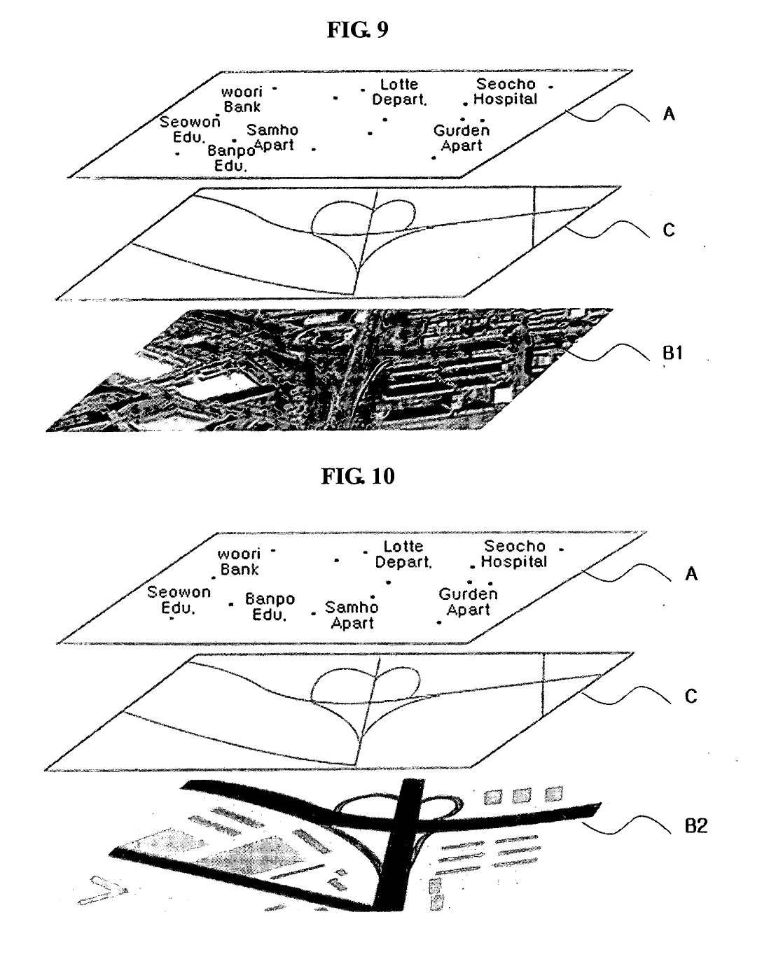

An aerial photograph illustrated in FIG. 5, a topographical image showing a topographical image illustrated in FIG. 6, or an illustrated map illustrated in FIG. 7 may be employed as background data of the geographic data. Preferable configuration of the geographic data according to background data will be described with reference to FIGS. 9 to 11.

FIG. 9 is a diagram illustrating a map image in the case of adopting an aerial photograph as background data.

As illustrated in FIG. 9, a map image overlaps graphic data A for indicating point data corresponding to an indication area, background data B1 that is an aerial photograph corresponding to the indication area, and road network data C corresponding to the indication area.

FIG. 10 is a diagram illustrating a map image in the case of adopting a shaded image as background data.

As illustrated in FIG. 10, a map image overlaps graphic data A for indicating point data corresponding to an indication area, background data B2 that is a topographical image corresponding to the indication area and road network data C corresponding to the indication area.

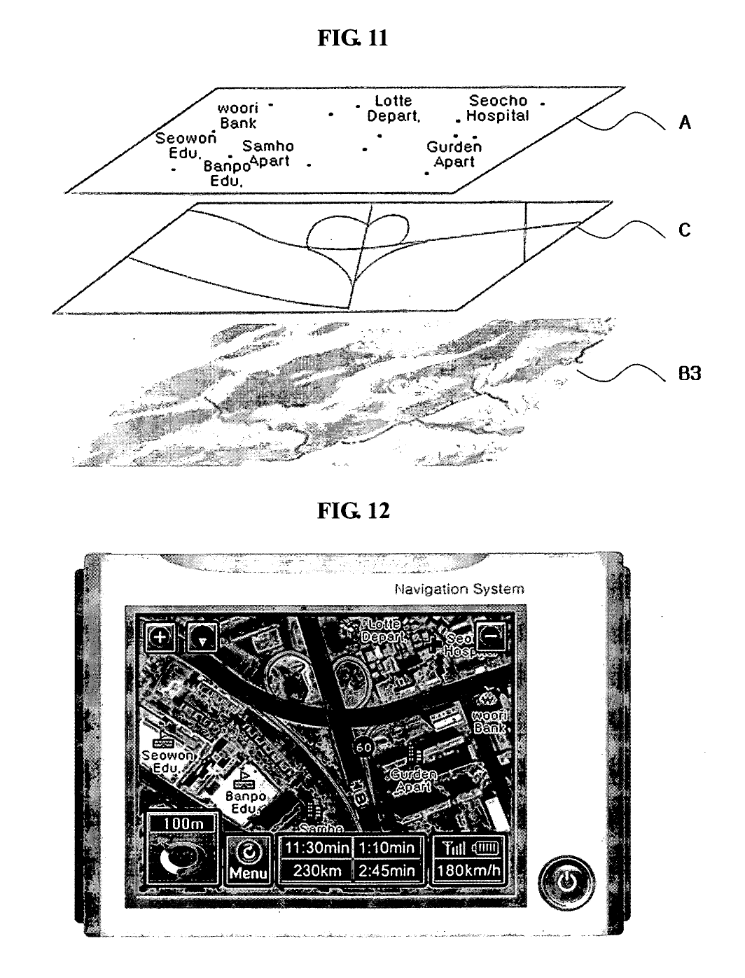

FIG. 11 is a diagram illustrating a map image in the case of adopting a graphically processed illustration image as background data.

As illustrated in FIG. 11, a map image overlaps graphic data A for indicating an indication area, background data B3 that is an illustrated map corresponding to the indication area and road network data C corresponding to the indication area.

In particular, the present may adopt an aerial photograph or a satellite photograph or a topographical image illustrated in FIGS. 5 and 6, as the background data. Accordingly, the present invention may quickly cope with the transformation of a topographical object and reduce the operation for maintenance and repair.

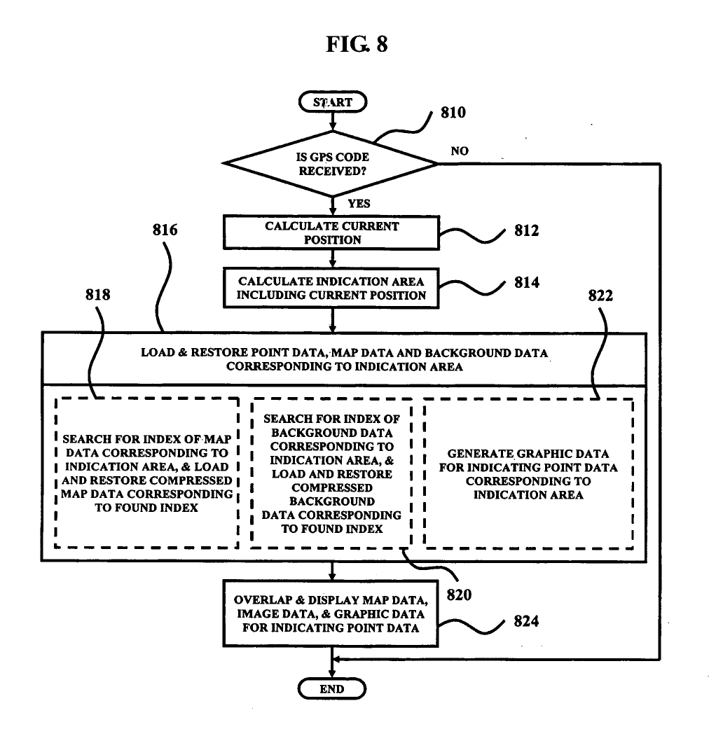

How the navigation service terminal 120 constructs a map image by using the aforementioned geographic data will be described in detail with reference to FIG. 8.

In step 810, the controller 210 of the navigation service terminal 120 checks whether a GPS code is received from the GPS satellite 110. In step 812, when the GPS code is received, a current position is calculated on the basis of the received GPS code. In step 814, when the current position is calculated, the controller 210 calculates an indication area including the current position. In this instance, the indication area may be an area corresponding to a map image displayed on the display 222. Also, the indication area may be an area including a predetermined distance from the current position.

In step 816, when the indication area is calculated, the controller 210 extracts geographic data corresponding to the indication area and restores the extracted geographic image. If further describing a process of extracting and restoring the geographic data, the controller 210 searches for an index of map data corresponding to the indication area and loads compressed map data corresponding to the found index from the database 214 in step 818. Also, in this step 818, the controller 210 restores the compressed map data. In step 820, the controller 210 searches for an index of background data corresponding to the indication area and loads compressed background data corresponding to the indication area from the database 214. Also, in this step 820, the controller 210 restores the compressed map data. In step 822, the controller 210 loads point data corresponding to the indication area from the database 214 and generates graphic data for displaying the loaded point data on the map image.

As described above, when restoration of map data and background data and generation of graphic data for indicating point data is completed, the controller 210 overlaps the restored map data and background data, and graphic data for indicating point data. Also, the controller 210 generates map image data and displays the generated map image data to the display 222.

A map image displayed on the display 222 will be described with reference to FIGS. 12 to 14.

FIG. 12 is a diagram illustrating an example of adopting an aerial photograph as background data.

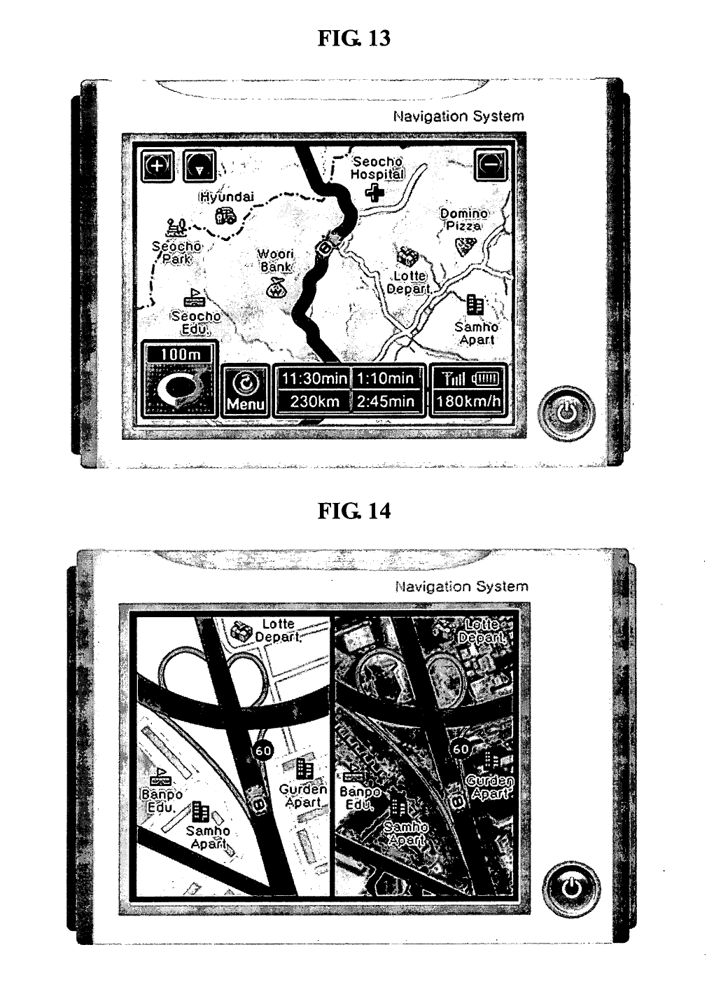

FIG. 13 is a diagram illustrating an example of adopting a topographical image as background data.

FIG. 14 is a diagram illustrating an example of segmenting a display screen and adopting an illustrated map and an aerial photograph on each segmented screen as background data.

As illustrated in FIGS. 12 to 14, the present invention may adopt various types of images as background data. In particular, the present invention may adopt an aerial photograph or a satellite photograph as background data. Accordingly, the present invention may quickly cope with the transformation of a topographical image and effectively manage a database. Through this, it is possible to prevent the database from becoming large.

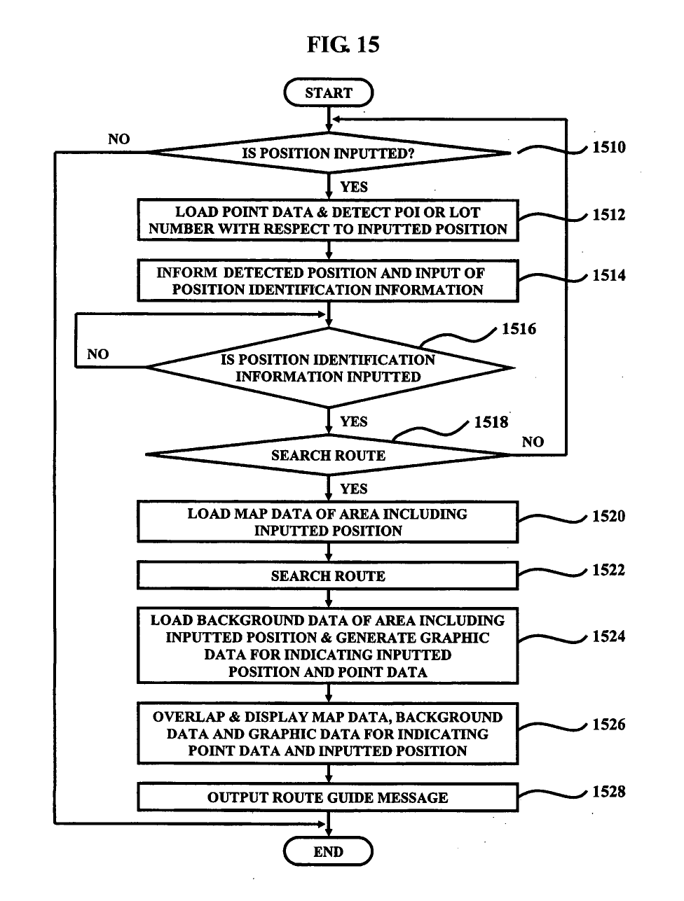

A process of providing a route guide service according to the present invention will be described with reference to FIG. 15.

In step 1510, the controller 210 of the navigation service terminal 120 checks whether a user inputs a position for searching a route via the user interface 218. In step 1512, when the user inputs a position for searching a route, the controller 210 loads point data from the database 214, to detect a POI or point data corresponding to the inputted position. Also, in step 1512, the controller 210 detects the POI or block number corresponding to the position inputted by the user from the loaded point data. In step 1514, when the detection of the POI or lot number is completed, the controller 210 controls the navigation service terminal 120 to guide the user to the detected position” if this is changed, need to also change FIG. 15] and requests the user to input position identification information. In step 1516, the navigation service terminal 120 according to the present invention determines whether position identification information is inputted by the user.

In step 1518, when the user inputs position identification information according to the request, the controller 210 checks whether a route search with respect to the position inputted from the user is requested. In the case the route search is not requested, the controller 210 goes back to step 1510 for receiving a position and position identification information.

In step 1520, when the user requests the route search, the controller 210 retrieves an index of map data with respect to an area including inputted positions, loads map data corresponding to the index from the database 214 and restores the loaded map data.

In step 1522, the controller 210 calculates a route connecting the positions from the restored map data. Since the process of calculating a route is an already well-known art, detailed description related thereto will be omitted.

In step 1524, when the route is calculated, the controller 210 retrieves an index of background data with respect to an area including the inputted positions, loads background data corresponding to the index and restores the loaded background data. Also, in step 1524, the controller 210 generates graphic data for indicating point data with respect to an area including the inputted positions and a position inputted from the user.

In step 1526, the controller 210 overlaps the restored map data, the restored background data and graphic data for indicating point data and the user's inputted position, generates map image data, and displays the generated map image data to the display 222.

In step 1528, the controller 210 outputs an audio signal with respect to an information message of the calculated route via the speaker 226.

The navigation service method according to the present invention may be recorded in computer readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

Since the present invention utilizes an aerial photograph or a satellite photograph as a background image in a map, it is possible to quickly cope with the transformation of a topographical object. Also, it is possible to readily perform maintenance and repair.

Also, since the present invention adopts an aerial photograph or a satellite photograph as a background image in a map, it is possible to effectively manage background data. Also, it is possible to prevent a database from becoming large.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A navigation service method using geographic information, comprising the steps of:
storing geographic data in a database, the geographic data comprising network data indicating geographic coordinates, calculating a route, and matching a GPS (Global Positioning System) code received from GPS satellites and the geographic coordinates, point data having position information from a search, and background data that is an aerial photograph or a satellite photograph;
searching for a desired position or calculating a current position according to a GPS code in the case of receiving the GPS code from the GPS satellites;
loading background data and map data of a predetermined area including the current position from the database; and
generating map image data overlapping the loaded map data and background data and displaying the generated map image data to a display.

2. A navigation service method using geographic information, comprising the steps of:
storing geographic data in a database, the geographic data including map data for indicating geographic coordinates, calculating a route, and matching a GPS code received from GPS satellites and the geographic coordinates, background data that is an aerial photograph or a satellite photograph, and point data indicating a point of interest;
loading the point data from the database and detecting points of interest with respect to a plurality of positions on the route requested for search, in the case a request for searching a route is received via a user interface;
loading the map data from the database to detect a route connecting the points of interest, in the case the points of interest are detected;
loading point data, and map data and background data with respect to a predetermined area from the database, in the case the route is calculated; and
generating map image data overlapping the loaded map data and background data and graphic data for indicating the route and point data, and displaying the generated map image data to a display.

3. The method of claim 1, wherein:
the map data and background data are tiled in plurality and compressed, each compressed map data and background data assigned with an index, and
map data and background data corresponding to the predetermined area are searched by the index and the found compressed map data and background data are loaded and restored.

4. The method of claim 2, wherein:
the map data and background data are tiled in plurality and compressed, each compressed map data and background data assigned with an index, and
map data and background data corresponding to the predetermined area are searched by the index and the found compressed map data and background data are loaded and restored.

5. A computer readable record medium recording a program for implementing the method according to claim 1.

6. A navigation service terminal using geographic information, comprising:
a database storing geographic data including map data for indicating geographic coordinates, calculating a route and matching a GPS code received from GPS satellites and the geographic coordinates, and background data that is an aerial photograph or a satellite photograph;
a display displaying map image data;
a GPS receiver receiving a GPS code from GPS satellites;
a memory storing predetermined types of information; and
a controller receiving a GPS code from the GPS receiver to calculate a current position, loading map data and background data with respect to a predetermined area including the current position from the database, generating map image data overlapping the loaded map data and background data, and displaying the generated map image data to the display.

7. The terminal of claim 6, further comprising a user interface providing an interface with a user, wherein:
in the case a request for searching a route is received via the user interface, the controller loads the point data from the database to detect points of interest with respect to a plurality of positions on the route requested for search, loads the map data from the database to calculate a route connecting the points of interest, loads point data, and map data and background data with respect to a predetermined area including the route, generates map image data overlapping the loaded map data and background data, and graphic data for indicating point data and the route, and displaying the generated map image data to the display.

8. The terminal of claim 6, further comprising a wired/wireless network interface providing an interface with a wired/wireless network, wherein:
the controller accesses a navigation service server via the wired/wireless network interface, downloads updated geographic information, and updates geographic information of the database.

9. The terminal of claim 6, wherein any one of a topographical image and an illustrated map image is used as the background data.

10. The terminal of claim 6, wherein:
the map data and background data are tiled in plurality and compressed, each compressed map data and background data assigned with an index, and
the controller searches for map data and background data corresponding to the predetermined area by the index, and loads and restores the found compressed map data and background data.
